(19) United States
(12) Patent Application Publication
(10) Pub. No.: US 2005/0277470 A1
(43) Pub. Date: Dec. 15, 2005

(54) Control unit for controlling a sophisticated character

(76) Inventor: Susornpol Joe Watanachote, Bangkok (TH)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/868,644

(22) Filed: Jun. 14, 2004

(51) Int. Cl. A63F 13/00

(52) U.S. Cl. 463/37

(57) ABSTRACT

An apparatus for controlling a complex character includes a body having a first side and a second side, the first side and the second side being independently moveable, and an actuator disposed between the first side and the second side of the body, the actuator being configured to generate control commands in response to a relative movement of the second side or the first side, wherein the body is configured to provide control of at least nine axes of motion associated with the complex character.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### FIELD

The present system and method relate to the control of a sophisticated character using a joystick control unit. More particularly, the present system and method control a sophisticated graphical or remote machine character in two and three dimensional environments.

### BACKGROUND

There are many types of control mechanisms that are designed to direct graphical characters in video game systems and computer systems. Similar technologies are used to control tangible objects such as remote control machines including toy cars, toy airplanes, or robots. However, as graphical characters and remotely controlled tangible objects increase in complexity, having two and three dimensional capabilities, existing control mechanisms have been slow to adjust, thereby being ill-equipped to produce realistic movement for such sophisticated and demanding characters. Consequently, players and operators are often left feeling frustrated and disappointed.

When gamepads were first developed, they were welcomed by video game players. Gamepads are generally designed to be used for a wide rage of video games. They are light weight and can be held with two hands giving a greater degree of freedom for mobility. FIG. 1 illustrates a basic gamepad according to the prior art. As illustrated in FIG. 1, a basic gamepad includes thumb switches (8), index-finger switches or shoulder buttons (9), and a direction control switch (10). As the use of gamepads became more prolific, the design of the gamepads adjusted to satisfy consumer needs. With intense gaming, players often sustain injuries such as bunions on the thumb that controls the direction control switch (10). To compensate for this, the direction control switch (10) on some designs is connected to a plastic rod (11) as illustrated in FIG. 2. The placement of the plastic rod (11) reduced injury and also increased synchronization in control.

FIGS. 3 through 5 illustrate an additional gamepad incorporated into the prior art. As illustrated in the top view of FIG. 3, a more ergonometric housing (12) replaced the housing of the basic game pad. As shown in FIG. 4, the ergonometric housing (12) includes two extensions that continue below the main plane of the gamepad. The side view illustrated in FIG. 5 further illustrates the ergonometric housing (12). The more ergonometric housing (12) illustrated in FIG. 5 allows the gamepad to be supported by the palms of both hands while allowing an improved hand grip by gripping with the ring and little fingers. However, the ergonometric design of the housing (12) does little or nothing to improve the button control by a user's fingers. Rather, the distance between buttons and the convenience of quickly actuating the various buttons remains very similar to the gamepad illustrated in FIG. 1.

More specifically, as illustrated in FIG. 5, the shoulder buttons (9) on existing gamepads are located close to the index-finger's base. Additionally, because the hand grips are formed underneath the housing, the angle of grasping fingers make it difficult for the player to interact with the shoulder buttons (9) quickly. Furthermore, since the thumbs are being used to control movement, the players cannot use them to support the grip while pressing shoulder buttons (9). Consequently, shoulder buttons (9) are only effective for inactive actions, or actions that require holding the button for long periods of time.

More recently, controllers have increased their precision through the incorporation of potentiometers. FIG. 6 illustrates a direction control stick (analog stick) (13) which gives a player a high level of control. Analog sticks (13) are usually constructed with two potentiometers to navigate X and Y axes simultaneously. A switch may also be placed underneath the analog stick (13) to generate the negative Z signal. However, since the analog stick (13) is designed to be controlled by a user's thumb, the negative Z button is often accidentally pressed.

In response to the demanding orientation control in 3 dimensional gaming, many gamepads today are constructed with two analog sticks (13); one for a user's left thumb and one for the user's right thumb. However, this method only provide 4 axis controls, 2 for X and Y axis, and another 2 for visual angle. Since both thumbs are used, it limits the potential for other fingers to control more switches or buttons.

In contrast to gamepads, joysticks allow a greater degree of freedom of control and are controlled by wrist and hand actions rather than finger movement. Traditionally, joysticks have been constructed of an ergonomic handle, for X-, and Y-axis control, and a base on which the handle is mounted. Joysticks are often designed for specific video games, especially for aircraft games and are not, therefore, as popular as the gamepad. Additionally, joysticks are designed to rest on a flat surface which restricts the players' freedom to move around while playing. Furthermore, in contrast to the ergonomic handle, the switches on the base of existing joystick designs are not usually ergonomically designed, making quick response difficult.

Recently, due to a high demand for three dimensional flight simulation, there have been some improvements in joysticks which allow control on more than two axis. One joystick configuration, designed by Measurement Systems, Inc., of Norwalk, Conn., allows movement in the X-, Y-, Z-, and yaw-Z axis. However, the degree of turn in the yaw-Z axis is limited to (+/−) 10 to 15 degrees. Moreover, the degree of yaw angle is achieved by the twisting of a user's wrist making a turn at greater degrees of angle difficult.

FIG. 7 illustrates a miniature joystick (16) coupled onto a larger joystick handle to allow simultaneous control of 4 axis; two to be manipulated by a user's hands, and two to be manipulated by a user's thumbs. However, as previously stated, the complexity of current three dimensional games call for an increasing number of controllable axis.

FIG. 8 illustrates a six axis mechanism as disclosed in U.S. Pat. No. 5,959,863 by Hoyt, et al. (1999). As illustrated in FIG. 8, the six axis mechanism may be incorporated into a joystick. However, there are a number of limitations in its use. As shown, the six axis mechanism is a single actuator module. Consequently, unintended inputs can easily occur and user can accidentally activate Y, or Z movements when trying to perform a pitch in the X plane. Additionally, the handle may not return to the exact same resting position causing a high frequency for zeroing in the neutral position, fine movement actions may cause the unintended moves, the yaw-axis is limited to a small degree of turn, and the device construction may not be sufficiently tough to withstand repeated use.

### SUMMARY

An apparatus for controlling a complex character includes a body having a first side and a second side, the first side and the second side being independently moveable, and an actuator disposed between the first side and the second side of the body, the actuator being configured to generate control commands in response to a relative movement of the second side or the first side, wherein the body is configured to provide control of at least nine axes of motion associated with the complex character.

### DRAWINGS

The accompanying drawings illustrate various exemplary embodiments of the present system and method and are a part of the specification.

FIG. 1 is a top view of an existing gamepad controller.

FIG. 2 is a perspective view of a traditional directional control switch having a plastic extrusion coupled to its center, according to the prior art.

FIG. 3 is a top view of an existing gamepad controller, according to the prior art.

FIG. 4 is a front view of the shoulder switches as implemented according to the prior art.

FIG. 5 is a side view of a traditional gamepad controller, according to the prior art.

FIG. 6 is a perspective view of a traditional gamepad controller, according to the prior art.

FIG. 7 is a perspective view of a traditional joystick, according to the prior art.

FIG. 8 is a cross-sectional view illustrating a six axis mechanism that may be used to control video games, according to the prior art.

FIG. 9 is a demonstrative view illustrating the control groups used to achieve optimum movements of a human character, according to one exemplary embodiment.

FIG. 10 is a perspective view of a set of axis that may be controlled by a first control group, according to one exemplary embodiment.

FIG. 11 is a perspective view of a set of directions and movements that may be controlled by a second control group, according to one exemplary embodiment.

FIG. 12 is a perspective view of a set of controlled movements that may be controlled by a third control group, according to one exemplary embodiment.

FIG. 13 is a screen shot illustrating the control of a vehicle character, according to one exemplary embodiment.

FIG. 14 shows the screen shot for a first person view game, according to one exemplary embodiment.

FIG. 15 is a side view illustrating a grip configuration on a surface having parallel sides, according to one exemplary embodiment.

FIG. 16 is a side view illustrating a grip configuration utilized with a surface having non-parallel sides, according to one exemplary embodiment.

FIG. 17 is an explode view illustrating the independent components of a complex control unit, according to one exemplary embodiment.

FIG. 18 is a perspective view illustrating the components of a joystick, according to one exemplary embodiment.

FIG. 19 is a side view illustrating the ability to access the components of a joystick, according to one exemplary embodiment.

FIGS. 20A through FIG. 20D illustrate the joystick handle orientations for various directional controls, according to exemplary embodiments.

FIG. 21 illustrates a left view of a complex control unit, according to one exemplary embodiment.

FIG. 22 illustrates a frontal view of the present complex control unit, according to one exemplary embodiment.

FIG. 23 is a perspective view of a complex control unit, according to one exemplary embodiment.

FIG. 24 illustrates a proper method for grasping and operating a complex control unit, according to one exemplary embodiment.

FIG. 25 illustrates a proper method for grasping and operating a complex control unit, according to one exemplary embodiment.

FIG. 26 illustrates a proper method for grasping and operating a complex control unit, according to one exemplary embodiment.

FIG. 27 illustrates a proper method for grasping and operating a complex control unit, according to one exemplary embodiment.

FIG. 28 illustrates a proper method for grasping and operating a complex control unit, according to one exemplary embodiment.

FIG. 29 is a planer top view illustrating a complex control unit, according to one exemplary embodiment.

FIG. 30 is a cross-sectional side view illustrating a complex control unit, according to one exemplary embodiment.

FIG. 31 is a top view illustrating a proper method for grasping and operating a complex control unit, according to one exemplary embodiment.

FIG. 32 is a cross-sectional side view illustrating a proper method for grasping and operating a complex control unit, according to one exemplary embodiment.

FIG. 33A through 33D illustrate possible ranges of motion available for operating a complex control unit, according to one exemplary embodiment.

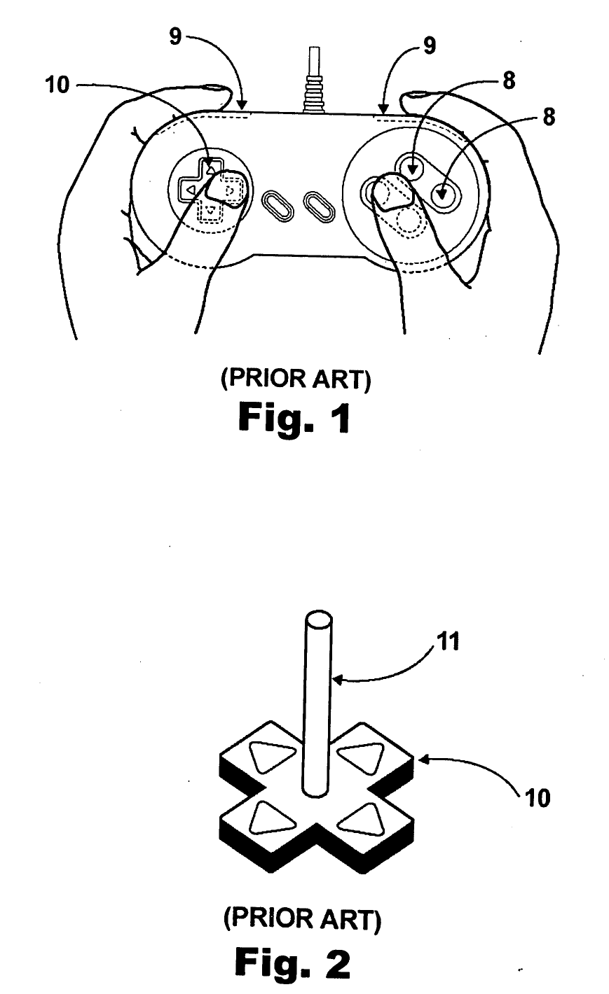

The illustrated embodiments are merely examples of the present system and method and do not limit the scope of the disclosure. Throughout the drawings, identical reference numbers designate similar, but not necessarily identical, elements.

### DETAILED DESCRIPTION

A number of exemplary systems and methods for controlling a sophisticated character are described in further detail below. More specifically, the present system and method provides a control unit configured to simultaneously allow at least 9 axis of control. While the present systems and methods are described, for ease of explanation only, in the context of a video game controller, the descriptions and illustrations are merely examples and are not intended to limit the present system and method to any specific use. Rather, the present systems and methods may be applied to the control of any number of complex characters including, but in no way limited to, remote control cars, remote control aircraft, weapons systems, robot systems, guidance systems, etc.

The phrase “complex character” shall be understood broadly, both here and in the appended claims, to refer to any one of a video game character, a remote control vehicle, a weapons guidance system, a robotic device, and the like.

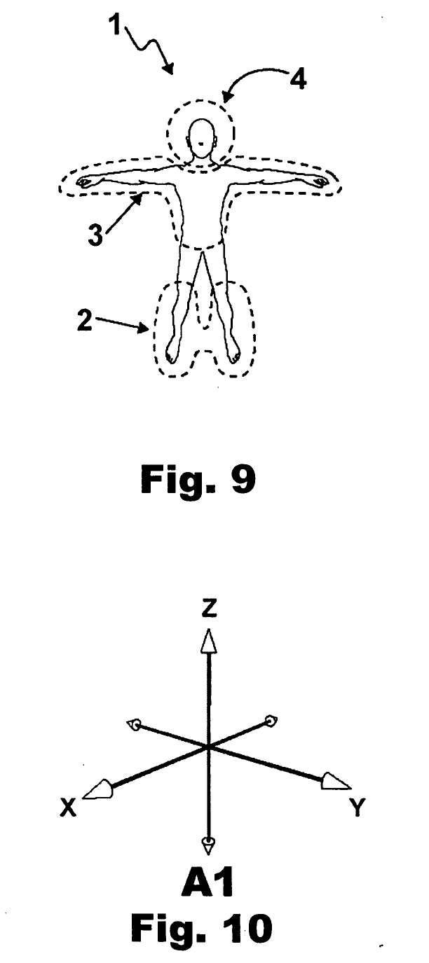

As illustrated in FIG. 9, characters in video games or other applications are often represented as human forms, animal forms, or vehicle forms and are increasingly sophisticated characters. FIG. 9 illustrates a human form character (1) including three basic interdependent control groups. As illustrated in FIG. 9, the human form character (1) includes a first control group (2) representing a human type character's lower body control. The second control group (3) represents the upper part of the human character's body excluding their head. The third control group (4) represents a human's visual angles. Control of each of these control groups will be explained in further detail below with reference to FIGS. 10 through 12.

FIG. 10 illustrates a first control group (A1), representing the lower body control (2; FIG. 9), of a human. According to one exemplary embodiment, the first control group is the fundamental mechanism for maneuvering the human form character (1; FIG. 9). Accordingly, the first control group (A1) allows the human form character (1; FIG. 9) to move in positive or negative X, Y, and Z directions in three dimensional space, as illustrated by the first control group (A1). According to one exemplary embodiment, motion in the X and/or Y direction is interpreted as a planar movement on a surface, motion in the positive Z direction is interpreted as a signal for jumping, and motion in the negative Z direction is interpreted as ducking. While exemplary interpretations for each of the directions in the first control group (A1) are given above, any number of interpretations may be used, depending on the application being incorporated.

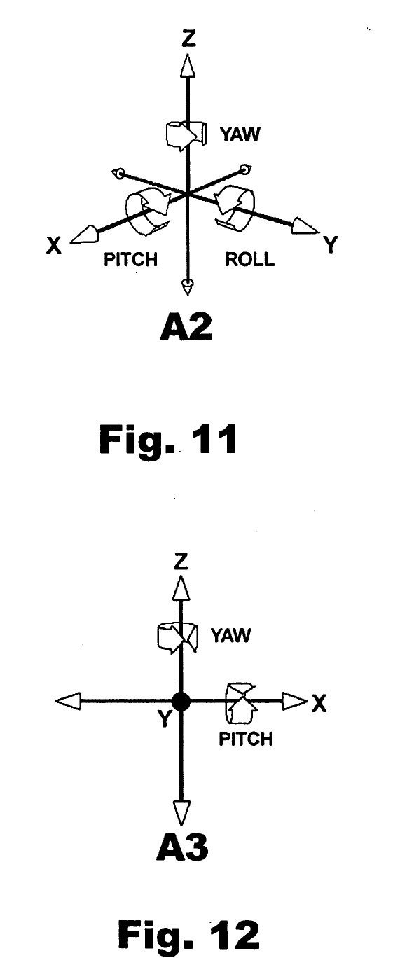

FIG. 11 illustrates the second control group (A2), according to one exemplary embodiment. As mentioned previously, the second control group (A2) may be interpreted as representing the upper portion of a human character (3, FIG. 9). According to one exemplary embodiment, the upper arm portion of the human character (3; FIG. 9) includes, but is not limited to, shoulders, arms, hands, abdomen, and back. Consequently, these axes are interdependent of the first group (A1; FIG. 10) and are referred to in FIG. 11 as rotating axes: yaw-Z, pitch-X, and roll-Y.

The third control group (A3) is illustrated in FIG. 12. As mentioned previously, the third control group may be interpreted as the visual angles (4, FIG. 9) experienced by the human character (1; FIG. 9). As shown, the third control group is also represented as rotating axes (A3). In a three dimensional perspective, according to one exemplary embodiment, a character is conventionally looking toward the positive Y axis (into the page). The pitch-X and yaw-Z axes will control the visual angle in the three dimension direction in which the character is looking, as represented by the rotating axes (A3). In this exemplary control group, the roll-Y axis which represents a bending of a character's neck may not be necessary. However, some applications may require zoom-in or zoom-out of visual viewing, therefore having the (+/−) Y axis mechanism is useful for a number of applications.

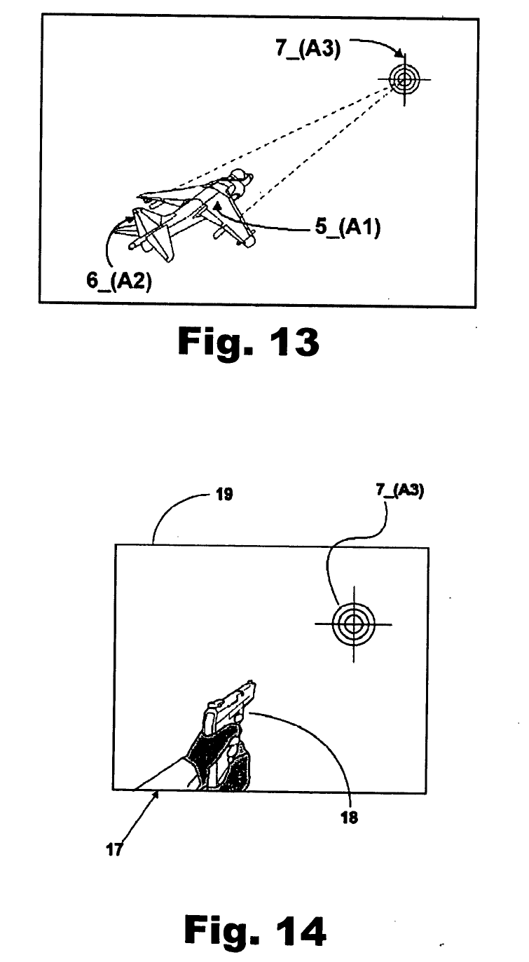

Another common video game character, beside a human form character (1; FIG. 9) is a vehicle form. A number of vehicles may be incorporated as video game characters including, but in no way limited to, aircraft, spacecraft, submarines, automobiles, motorcycles, snowmobiles, bicycles, skateboards, etc. Generally, these characters also require the input of the three control groups (A1; FIG. 10, A2; FIG. 11, and A3; FIG. 12) similar to those explained above for the human character. FIG. 13 illustrates the location of each control group mechanism as applied to a common aircraft style character. In the exemplary embodiment illustrated in FIG. 13, the first control group (A1) controls the main wings and the thrust (5), second control group (A2) controls the elevators and the rudder (6) of the aircraft character, and third control group (A3) controls the floating target (7).

While the aircraft in the exemplary embodiment illustrated in FIG. 13 may not require the Z axis mechanism in the first control group (A1), typically reserved for jumping or crouching, the unused mechanisms may be assigned alternative triggering functions. According to one exemplary embodiment, the Z axis mechanism can be used for other features such as controlling the height of the aircraft character or for taking-off when the aircraft is on the ground. An infinite number of applications can be applied to the Z axis mechanism. Nevertheless, characters such as a spacecraft, or a helicopter, would require the Z axis for an enhanced gaming experience.

In contrast to the exemplary embodiment illustrated in FIG. 13, floating targets (7) used to represent weapon guidance systems in traditional aircraft games and applications are typically controlled by the main first control group (A1). Use of the main first control group (A1) to vary the position of the floating targets (7) reduces the reality of the gaming experience because in real world applications aircraft may be controlled by two operators or they may be equipped with targeting devices, making shooting in various directions possible. Consequently, the reality is that the aiming and discharge of a weapons system does not directly effect the aircraft orientation as is typically experienced in video game applications.

FIG. 14 illustrates a screenshot (17) of a three dimension shooting game. The gun (18) is pointing toward a floating target (7) which is controlled by third control group (A3; FIG. 12). The angle of viewing (19) in the first-person view (which is the same view as a player would see from the screen (17)) is suggested to be controlled by second control group (A2; FIG. 11). The second control group (A2) is a less precise control mechanism than the third control group (A3). The character's mobility will be controlled by first control group (A1; FIG. 10) as described above with reference to FIG. 9. In the present embodiment, the player may pan for the targets without directly affecting the character's orientation or the gun's direction. Additionally, the present systems and methods allow the character to turn and move in a first direction while shooting in a second direction; a feat that has never been possible with traditional character manipulation devices.

Third person view orientations such as that illustrated in FIG. 13 are popular game configurations. By incorporating a plurality of control groups, the present systems and methods will dramatically improve the gaming experience for a player. In soccer games for instance, the characters have never been able to jump, duck, or pass the ball accurately to other characters due to the limitation of the current game control mechanisms, mentioned previously. However, with the proposed multi-control group conventions, the first control group (A1; FIG. 10) will allow the selected character to be able to run, jump, and duck in three dimensional space. Ball passing and shooting directions will be controlled by the second control group (A2; FIG. 11) and it will be possible to pass the ball accurately with a high or low trajectory, and/or with side spin in directions independent from the current character's orientation. Moreover, the third control group (A3; FIG. 12), will allow the player to navigate the viewing screen to see the location of other characters that are off the view screen, e.g. the goalkeeper. These features and movements are not achievable with existing game control units. Consequently, players using traditional control units often have to guess as to a character's position when they are off the viewing screen.

Third person view fighting games are also popular. With the present system and method, character control will be similar to the controls explained. The player will be able to take full advantage of the second control group (A2; FIG. 11) to allow the character to bend its back, sway its shoulders, and dodge blows without moving its feet. Additionally, the player will then be able to make the character give left or right arm and leg blows easily again using the second control group (A2; FIG. 11). The third control group (A3; FIG. 12) can be used to anticipate off screen objects and/or it can also be used for inputting a combo code associated with special moves.

The first-person view gaming technique is a popular design for three dimensional shooting games, driving games, flight simulation games, etc. For flight simulation and driving games, the orientation-control by the first person view is very natural to the player for a number of reasons. First, the vehicle character, by its nature, does not have the amount of flexibility required to quickly change its direction of mobility. As when driving a car, the mobility controls are moving forward, backward, and turning. However, when turning, it is not possible to do this movement without also using the forward or backward motion. When there are more activities involved such as multi-direction shooting, and glancing or viewing, it is increasingly difficult to control the character with existing control units.

Existing first-person view shooting games with human characters are also controlled in a similar manner to those described previously; by tying the turning functionality with the forward and/or back motion. However, since a human character is not a vehicle, controlling the character in this way is physiologically incorrect. That is, physiologically, humans do not turn in a curve like a car does; additionally humans do not often walk backward blindly. Rather, humans typically turn quickly and walk directly facing forward.

While most traditional gamepads have been designed to be controlled by thumbs, with as many as four to six switches being controlled by a thumb, securely grasping a gamepad controlled mainly by thumbs can be somewhat awkward. Additionally, three dimensional games require so many buttons to achieve the full range of movements that it will be physically impossible for a player to control all the buttons by thumbs alone.

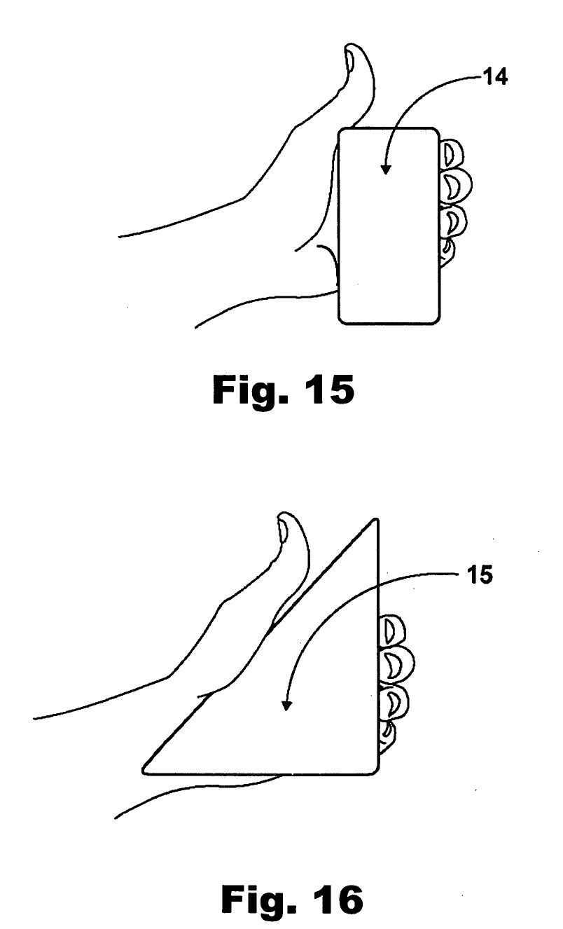

FIGS. 15 and 16 illustrate, without using the thumb, a hand holding a rectangular block (14) and a triangle block (15) respectively. It can be observed from a comparison of FIGS. 15 and 16 that the configuration that holds the rectangular block (14) is much more stable and each finger can generate more pressure on the block. In general, if the block has parallel back and front edges, a strong grip can be generated by the palm and fingers.

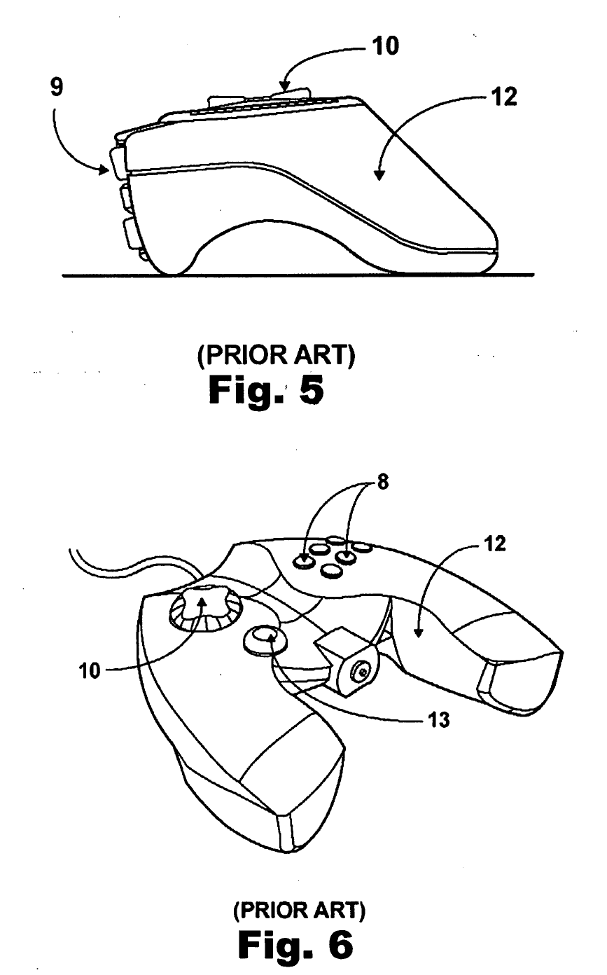

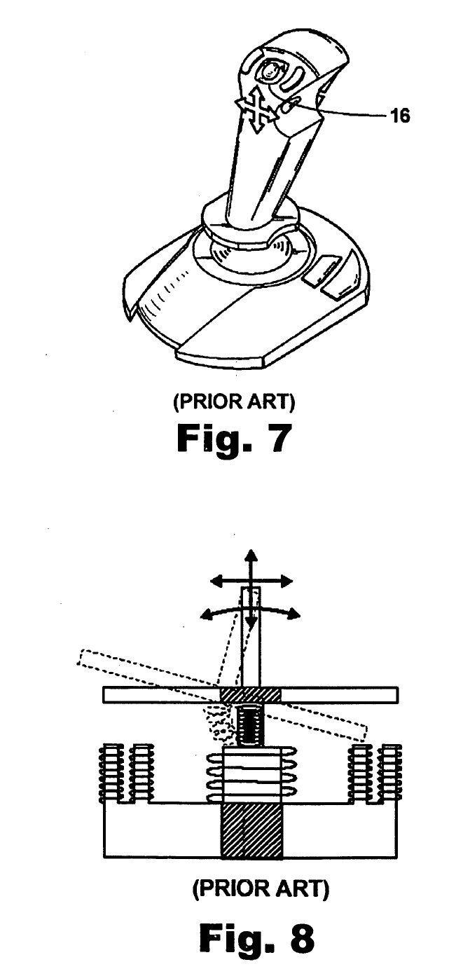

In contrast, the configuration illustrating a hand holding a triangular block (15) in FIG. 16 is less stable and more likely to slip from the grasp of the hand. Comparing FIG. 5 to FIG. 16, the instability of the triangular block explains why the traditional index-finger switches (9) incorporated on traditional gamepad controllers cannot be effectively used. Even with the added support of a thumb, the increased stability is not sufficient to fully stabilize the gamepad.

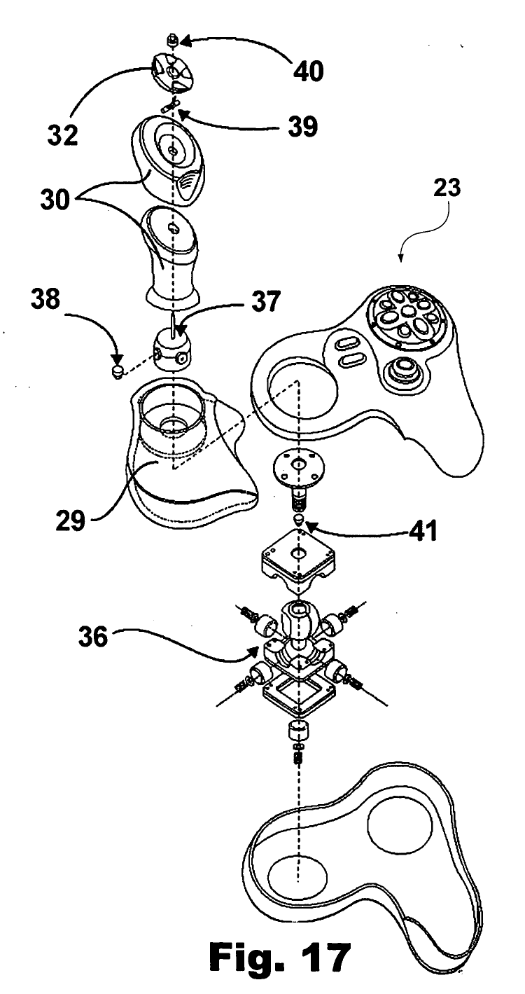

The present character control unit illustrated in FIG. 17, provides a force feedback handheld joystick structure that allows a minimum of 9-axis of control, with the direction controls separated into three groups. More specifically, FIG. 17 is an exploded view of the present character control unit, according to one exemplary embodiment. The detail of the exploded view illustrated in FIG. 17 focuses only on the basic construction of the handle and the base of the character control unit. As illustrated in FIG. 17, the present character control unit includes a bottom housing member configured to receive and support a number of control elements including, but in no way limited to, a joystick actuator (36) having a switch (41) coupled thereto. Additionally, a handle base (29) is coupled to the bottom housing and the joystick actuator (36). A potentiometer (37) and an associated switch (38) are coupled in the handle base (29) where they are coupled to a mainjoystick (30). Moreover, as shown in FIG. 17, the main joystick (30) includes a mini-joystick (39) associated with a deep dish shape stick (32) and a switch (40). Additionally, an active switch control unit (23) is illustrated in FIG. 17 including a number of action switches. Additional detail of the components of the present character control unit will be given below.

As illustrated in FIG. 17, the joystick actuator (36) may be formed to include a number of switches. Depending on the manufacturer, joystick actuators are often created with four side switches configured to generate planar motion signals and to hold the handle in position. Additionally, a bottom switch can be added for generating negative Z signal and a top switch (41) may be included for generating positive Z signal of first control group A1. According to one exemplary embodiment, a potentiometer (not shown) is installed inside the joystick actuator (36) to create a yaw-Z signal for the second control group (A2; FIG. 11). However, according to one alternative embodiment, the joystick actuator (36) can also be created using solely potentiometers rather than switches. As illustrated in FIG. 17, the handle base (29) is moveably coupled to the base of the character control unit such that when the user manipulates the handle base (29), control signals will be generated in the joystick actuator (36).

Additionally, as illustrated in FIG. 17, the main joystick (30) is installed on the potentiometer (37) that is coupled to and installed on the handle base (29). According to one exemplary embodiment, the potentiometer (37) is configured to create control signals for the second control group (A2; FIG. 11). According to one exemplary embodiment, in addition to generating traditional joystick control signals, the potentiometer (37) is configured to sense a rotation of the main joystick (30) to be interpreted as an pitch or roll control signal for the second control group (A2; FIG. 11). Additionally, there is a switch (38) for generating positive Z signals for first control group (A1; FIG. 10), if not already installed on the base joystick actuator (36).

While the present character control unit is described herein as employing a number of potentiometers and switches to generate signal data, any number of control unit components may be used. Additional control units that may be used in the construction of the present character control unit include, but are in no way limited to, optical encoders, switch arrays, piezo-electric transducers, strain-gauges, capacitive coupling devices, inductive coupling devices, or magnetic devices. Additionally, any number of springs, elastomeric rings, rubber bladders, flexible diaphragms, and/or rubber feet may be employed to return switches or actuator handles to their neutral positions. According to one exemplary embodiment, a combination of all of the above devices may be necessary to meet all the requirements of a full range of character movement. Alternatively, a custom made single actuator for 6 axes can also be used in conjunction with a hand grip technique that will allow further number of control beyond 9 axes possible by one hand.

Continuing with FIG. 17, the mini-joystick (39) and switch (40) are coupled to the main joystick (30) by the dish shape joystick (32). According to one exemplary embodiment, the dish shape joystick (32) may be used to input control signals, using the mini-joystick (39) and switch (40), to the third control group (A3; FIG. 12).

Alternative to the embodiment illustrated in FIG. 17, the switch (40) can be replaced by yet another mini-joystick, so that the (+/−) Y signal in the third control group (A3; FIG. 12) can be created in one location. Moreover, additional switches can be added to the main joystick (30) as needed. Consequently, the first control group (A1; FIG. 10) be controlled by hand actions and the second control group (A2; FIG. 11) will be controlled by fingers and wrist actions while the third control group (A3; FIG. 12) will be controlled by the thumb action.

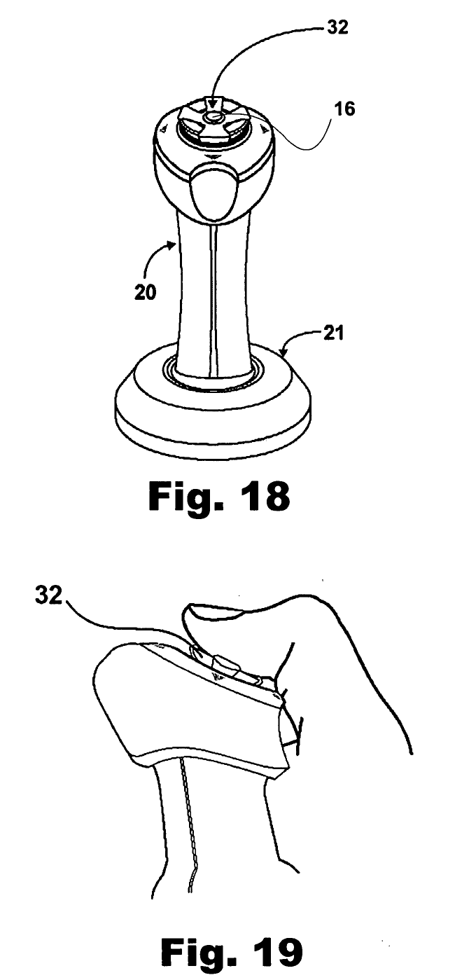

FIG. 18 illustrates an assembled view of the dish shaped joystick (32) coupled to a simple joystick handle portion (20) of the main joystick (30; FIG. 17). According to one exemplary embodiment, the third control group (A3; FIG. 12) is controlled by thumb action inputting controls through the dish shaped joystick (32). Consequently, players can tilt the mini-joystick (39; FIG. 17) through manipulation of the dish shaped joystick (32) with a thumb to control yaw-Z and pitch-X simultaneously. A positive Y signal can be created by pressing down on the switch (40; FIG. 17). Further illustrated in FIG. 18, a positive Y switch (16) is disposed in the middle of the dish shaped joystick (32). According to one exemplary embodiment, the positive Y switch (16) serves as a positive Y switch which can be reached by using the tip of the thumb

FIG. 19 illustrates a user actuating the dish shaped joystick (32) with a thumb. As illustrated in FIG. 19, the placement of a user's thumb may serve to actuate both the disk shaped joystick (32) and the positive Y switch (16; FIG. 18). Unlike existing designs, the positive Y switch of third control group A3 is independent from the thumb that controls the stick. As illustrated in FIG. 19, the dish shaped joystick (32) has a shape of a deep dish which allows easy tilting.

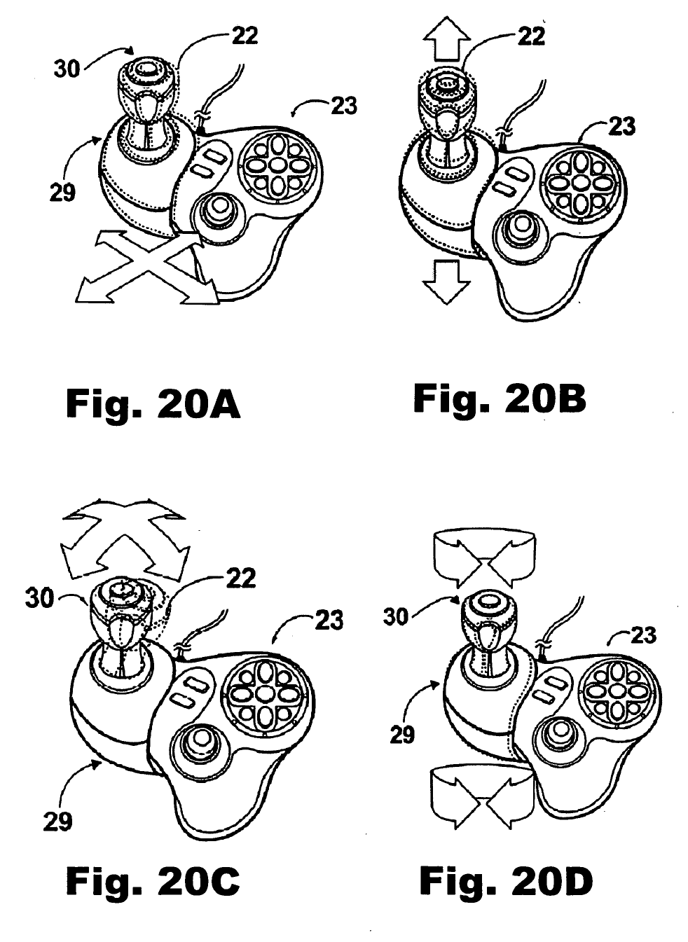

FIG. 20A illustrates the control of the X-axis and the Y-axis in the first control group (A1; FIG. 10) by manipulating the handle base (29) which can be moved horizontally to the control unit (23). As illustrated in FIG. 20A, the dotted line (22) indicates the translated position of the handle base (29) and the handle (30) when controlling the X and Y axis. As the handle base (29) and the handle (30) are translated, a number of control signals corresponding to the X-axis and the Y-axis in the first control group (A1; FIG. 10) are generated by the joystick actuator (36; FIG. 17). Additionally, as noted above, a number of springs, elastomeric rings, rubber bladders, flexible diaphragms, and/or rubber feet may be used to return the handle base (29) automatically to its original position when released.

FIG. 20B illustrates the pulled action used to generate positive Z-axis control, according to one exemplary embodiment. As illustrated in FIG. 20B, the handle base (29) may be lifted in a positive Z direction to generate a positive Z command in the joystick actuator (36; FIG. 17). The dotted line (22) illustrated in FIG. 20B indicates the handle base (29) and the handle (30) lift off position. Similarly, the negative Z-axis can be controlled by pressing the handle base (29) down.

FIG. 20C illustrates that tilting the handle (30) will control the roll-X, and the pitch-Y axes in second control group (A2; FIG. 11), according to one exemplary embodiment. As illustrated by the dotted line (22) in FIG. 20C, the position of the handle (30) may be tilted to signal a roll-X or pitch-Y control. As illustrated in FIG. 20C, the pivot point for the tilting of the handle (30) is central on the handle base (29).

Continuing to FIG. 20D, the left side of the control unit is twisted to illustrate that the handle base (29) can be twisted to generate a yaw-Z signal, according to one exemplary embodiment. According to this ergonomic design, the handle base may be rotated with wrist action without changing hand position.

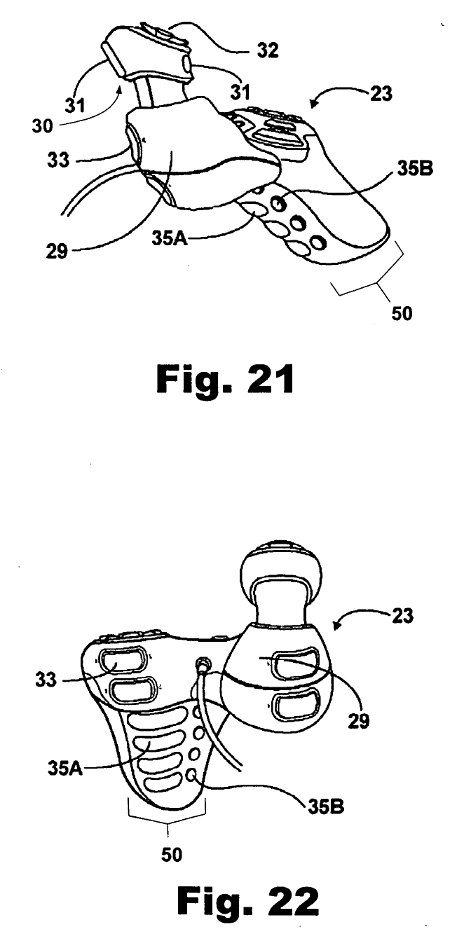

The perspective views illustrated in FIGS. 21 and 22 illustrate a number of control switches that may be disposed on the present character control unit. According to one exemplary embodiment, a number of control switches can be installed on the main joystick (30), such as a trigger switch (31; FIG. 21) which can be used by the index finger or thumb of a user. Similarly, shoulder switches (33; FIG. 21) can be implemented on the control unit (23) where they may be easily accessed by a user. FIG. 21 and FIG. 22 also illustrate a number of action switches (35A, 35B) disposed on a lower grip portion (50) of the present character control unit. As illustrated in FIG. 21, the lower grip portion (50) of the present character control unit may have any number of action switches (35A, 35B) disposed so as to be readily accessed by a user's fingers. According to one exemplary embodiment illustrated in FIG. 21 and FIG. 22, the action switches (35A, 35B) are constructed in two rows allowing eight extra switches to be controlled effectively by the user.

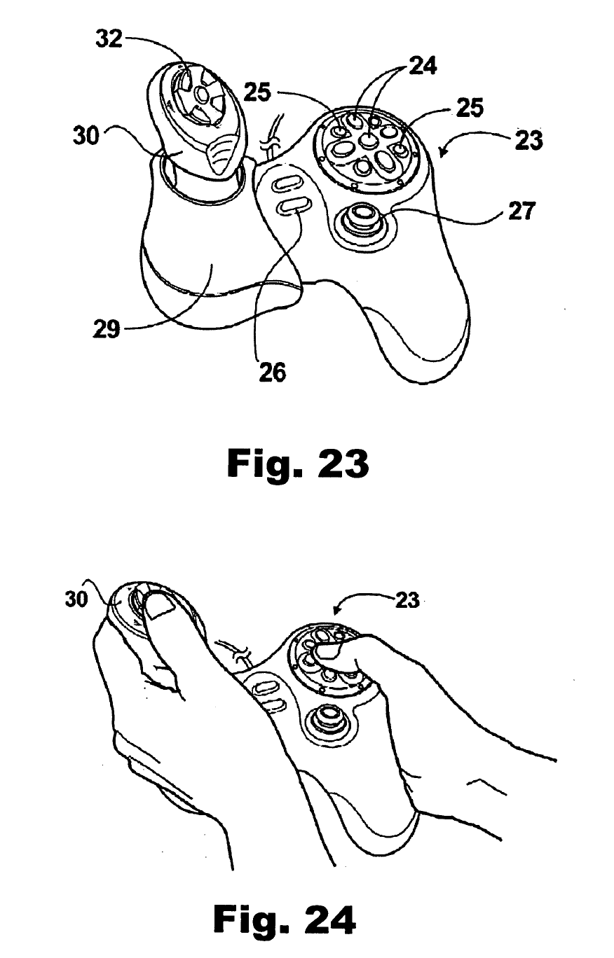

FIG. 23 shows a perspective view of the present control unit (23), according to one exemplary embodiment. As illustrated in FIG. 23, a number of main thumb switches, or action switches (24) are located on the right side of the control unit (23) and are laid out in cross shape to assist muscle memories. The action switch (24) in the middle of the other action switches illustrated in FIG. 23 will have a different texture so that when touched by a user's thumb, the different texture is sensed, making the player are aware of their relative thumb position. Additionally, more switches can be added as desired by the user. In the exemplary embodiment illustrated in FIG. 23, a number of smaller switches (25) have been placed diagonally to the slightly larger main thumb switches (24). This configuration allows up to nine action switches to be controlled by a thumb, while the switch locations remain easy to memorize. Additionally, the configuration illustrated in FIG. 23 allows for the possibility of two or more buttons being pressed simultaneously by a thumb or other digit.

FIG. 23 also illustrates a number of accessory switches (26) that may be installed on the controller housing as needed for such functions as a “START” or a “SELECT” button. A mini-joystick (27) is also shown disposed on the present control unit (23). According to the exemplary embodiment illustrated in FIG. 23, the mini-joystick (27) can be reached by the right-hand or the left-hand thumb. This dual access feature of the mini-joystick (27) will be useful if a player needs to control a character is using a sword as a weapon.

Optimum control of the present character control unit is achieved when a user's left hand is used to control the joystick handle with the right hand being used to support the control unit and to control action switches. As illustrated in FIG. 24, a user's left hand is holding the joystick handle while the right hand is supporting the control unit (23). When implemented as shown in FIG. 24, the weight of the control unit (23) is shifted toward the right side for balanced grasping. The grip of the right hand is similar to holding a handgun grip in that it creates a strong holding position due to opposing surfaces. Since the left hand does not support the weight imparted by the control unit (23), it can be freely used to independently control the joystick (30) and the handle base (29).

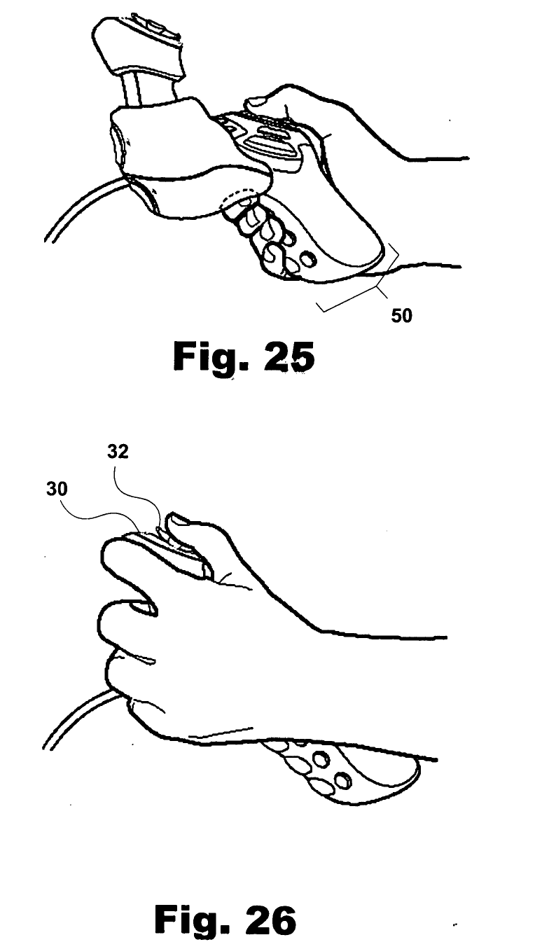

Referring back to FIG. 15, if the handle grip is almost parallel for the front and back edges, and the wrist is in a straight position, the grip created will be strong. As illustrated in FIG. 25, a user's right hand may grip the lower grip portion (50) of the present control unit (23) while maintaining a straight wrist to achieve a strong grip without the aid of the thumb. As illustrated in FIG. 25, the slanted shape of the lower grip portion of the present control unit (23) is designed to maintain the present control unit horizontal while the user's wrist remains straight, thereby eliminating a number of potential injuries caused by repeated use. Additionally, in contrast to traditional controllers, the present control unit's grip is designed according to the shape of a human palm, rather than design the grip for thumb switches.

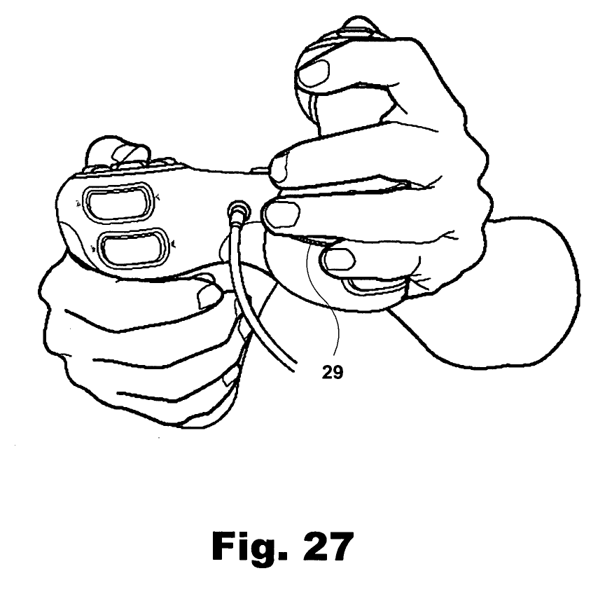

FIGS. 26, 27, and 28 illustrate the position of the left hand when operating the present control unit. As illustrated in FIG. 26, the left hand will securely grasp the handle base (29), while the user's index finger will wrap around the joystick (30) and the left hand thumb will actuate the disk shaped joystick (32). As shown in FIG. 27, the user's left pinkie and ring finger will be wrapped around the handle base (29) of the controller. The base (29) of the control unit can be comfortably gripped by the middle finger, the ring finger, the little finger and/or the palm of the left hand and can be controlled freely without the aid of the thumb. As mentioned previously, the base (29) will control X-, Y-, and Z-axis in the first control group (A1; FIG. 10) and yaw-Z axis in the second control group (A2; FIG. 11). The middle finger will be wrapped around the handle base (29) to easily control the negative Z-axis signals and will not be accidentally pressed when controlling X-, and/or Y-axis. As illustrated, the yaw-Z signal in the second control group (A2; FIG. 11) is generated by a wrist action.

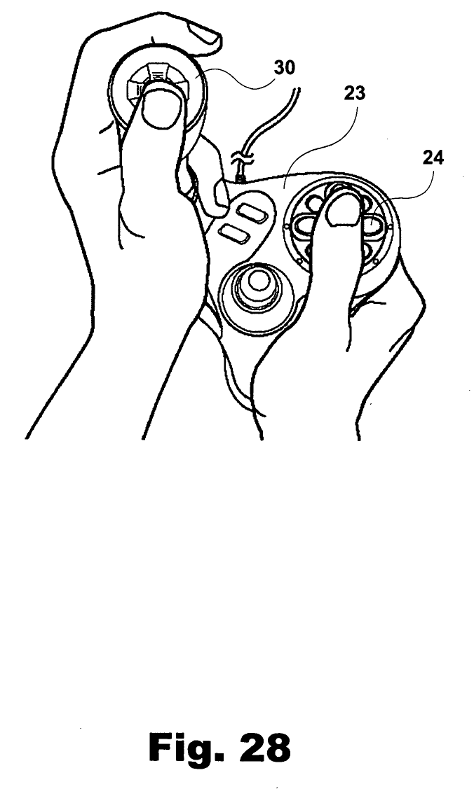

As shown in FIG. 28, the main joystick (30) will be gripped with the thumb base and the index finger of a user's left hand. With or without the thumb support, the main joystick (30) can be tilted and twisted to generate roll-X, and pitch-Y signals used by the second control group (A2; FIG. 11). Also illustrated in FIG. 28, part of the control unit (23) is supported on the base of the right index finger and the hand. In this configuration heavy pressing of the action switches (24) and use of the main joystick (30) by the left hand will not affect the use of the action switches (35A, 35B; FIG. 22) disposed on the lower grip portion (50; FIG. 22).

According to one alternative configuration, the base (29; FIG. 22) will control X-, Y-, and negative Z-axis in the first control group (A1; FIG. 10), while the main joystick (30; FIG. 22) will control positive Z-axis from the first control group (A1; FIG. 10) and, roll-X, pitch-Y, and yaw-Z axis from the second control group (A2; FIG. 11). The advantage of this configuration is that with the aid of the thumb, the main joystick (30; FIG. 22) can be lifted to generate positive Z signals in first control group (A1; FIG. 10). Additionally, gripping by the thumb and the index finger of the left hand, will allow the main joystick (30; FIG. 22) to be twisted more than (+/−) 135 degrees, which angle is more than could normally be created by a wrist action. However, one trade off of the alternative configuration is that the left thumb position will not be on the same position while controlling.

While the exemplary embodiments illustrated above demonstrate a number of asymmetrical housing control units, the shape of control unit (23) may be designed with a combination of one or more symmetrically shaped housings.

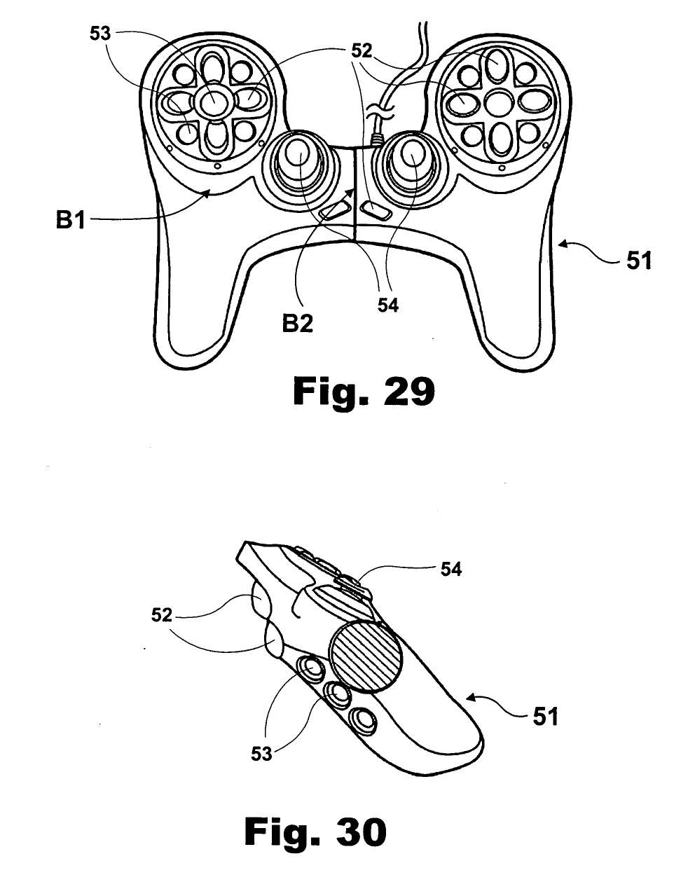

In contrast to the exemplary embodiments illustrated in FIGS. 17 through 28, FIGS. 29 through 33D illustrate a symmetrical control unit configured to control a complex character in at least nine axes of motion. As illustrated in FIG. 29, an ‘H’ shaped housing control unit (51) is shown from a top perspective, having a symmetrical shape reflected about a vertical axis (B2). While FIG. 29 illustrates a symmetrical control unit in the shape of an ‘H,’ the symmetric shape of the control unit can be designed in a number of different symmetric shapes including, but in no way limit to, shapes similar to one of the letters ‘T’, ‘U’, ‘V’, ‘M’, ‘U’, ‘O’, ‘D’, or ‘I’. For ease of explanation only, the present symmetrical control unit will be described in the context of an ‘H’ shaped control unit, as illustrated in FIG. 29.

Depending on the symmetric shape used to design the control unit, the preferred hand configuration may vary. That is, a user's hand orientation preference may vary with the symmetric shape of the controller. By way of example only, an ‘I’ shaped control unit would likely be held by a user with one hand on top of another hand or alternatively by holding the control unit horizontally.

As illustrated in the exemplary embodiment of FIG. 29, the ‘H’ shaped housing control unit (51) includes a number of buttons (52, 53) and/or joysticks (54) that may be installed on the controller housing as desired to control the complex character in at least nine axes of motion. The illustrated buttons (52, 53) and/or joysticks (54) may be configured and formed with any number of switches, potentiometers, and/or other mechanisms as previously described with reference to FIGS. 17 through 28. Additionally, as previously mentioned, any number of elastic mechanisms may be employed to restore the switches (52, 53) or joystick handles (54) to their neutral positions when actuation by a user has ceased. Moreover, the buttons (52, 53) can be formed having any number of shapes, textures, and/or surface characteristics configured to blindly inform a user of their relative finger position.

In order to adequately control the motion of a complex character in at least nine axes of motion using the symmetrical or ‘H’ shaped housing control unit (51), the control unit is configured to be actuated along the symmetric vertical axis (B2) illustrated in FIG. 29. That is, one or more actuators (not shown) may be formed in the symmetric vertical axis (B2) of the ‘H’ shaped housing control unit (51) allowing for character control commands to be transmitted as the symmetrical sides of the ‘H’ shaped housing control unit (51) are independently translated and/or rotated. Further details of the actuation of the ‘H’ shaped housing control unit (51) will be given below with reference to FIGS. 30 through 33D.

FIG. 30 illustrates a left cross-sectional view of an exemplary ‘H’ shaped housing control unit (51). Consequently, the left cross-sectional view illustrates the right side of the ‘H’ shaped housing control unit (51), according to one exemplary embodiment. As illustrated in FIG. 30, the ‘H’ shaped housing control unit (51) includes a number of action switches (52, 53) disposed on the front of the control unit, similar to those illustrated above with reference to FIGS. 17 through 28.

According to the exemplary embodiment shown in FIGS. 29 and 30, the action switches (53) located on the lower portion of the ‘H’ shaped housing control unit (51), when in their neutral positions, are indented into the control unit housing to prevent unintentional actuation; while the action switches (52) configured to be actuated by a user's pointer finger, when in their neutral position, are extruded out from the housing. The combination of these varying contour plane action switches and their layouts will allow further improvement for the combination of two or more buttons being pressed simultaneously by a thumb or other digit, and allow a better griping of the control unit without unintentionally actuating the switches.

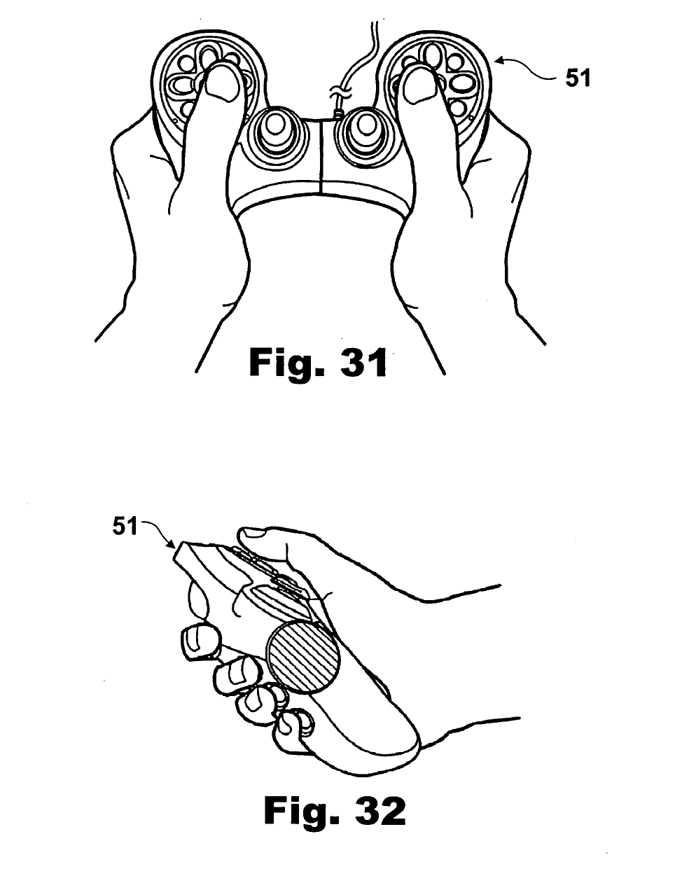

FIGS. 31 and 32 illustrate an exemplary method for gripping the exemplary ‘H’ shaped housing control unit (51), according to one exemplary embodiment. As illustrated in FIG. 31, a user may easily manipulate all of the buttons (52, 53; FIG. 29), actuators (52, 53, FIG. 30), and joysticks (54) of the control unit (51) without releasing the unit or reducing its support.

Additionally, as illustrated in FIG. 32, similar to FIG. 25, a user's right hand may grip the lower grip portion of the ‘H’ shaped housing control unit (51) while maintaining a straight wrist to achieve a strong grip without the aid of the thumb. Also illustrated in FIG. 32, the slanted shape of the lower grip portion of the present control unit (51) is designed to maintain the present control unit horizontal while the user's wrist remains straight, thereby eliminating a number of potential injuries caused by repeated use. Additionally, in contrast to traditional controllers, the present control unit's grip is designed according to the shape of a human palm, rather than design the grip for thumb switches. By facilitating the gripping of the control unit (51) while freeing the user's thumb, independent actuation of the two halves of the control unit (51) about the center vertical axis (B2; FIG. 29) is possible.

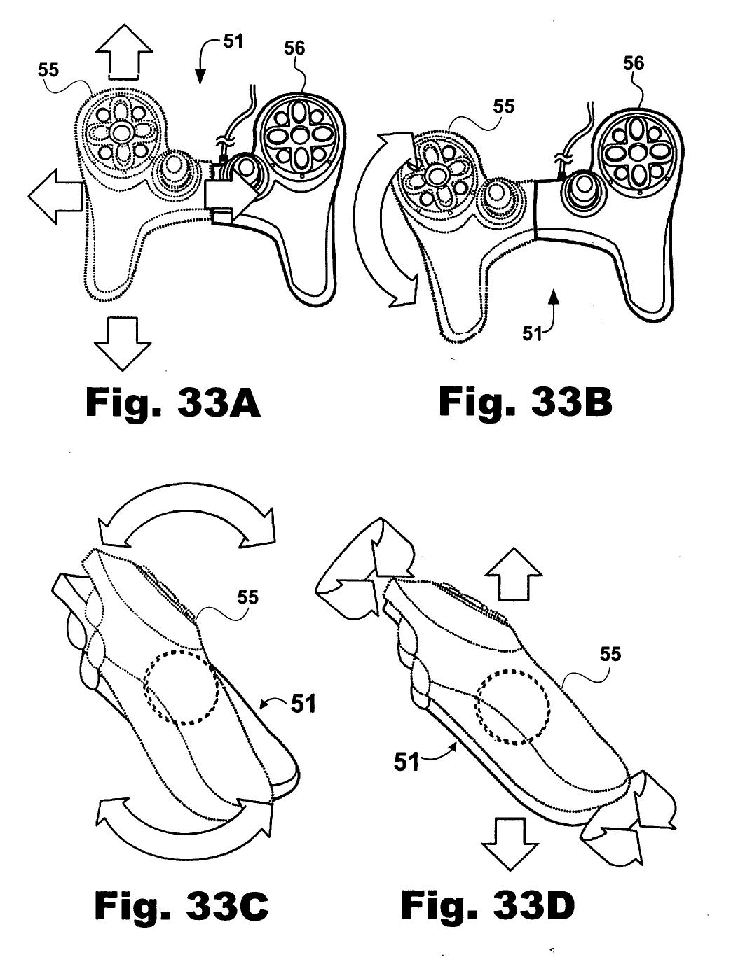

Similar to the exemplary embodiments illustrated above with reference to FIGS. 17 through 29, the actuators for generating up to 6 axes of motions are located on the two symmetrical sides of the exemplary control unit (51). Consequently, the remaining 3 axes of motion are controlled by the independent actuation of the symmetrical halves of the control unit (51) about the center vertical axis (B2; FIG. 29). Exemplary control of multiple axes of motion using the independent actuation of the symmetrical halves of the control unit (51) will be given below with reference to FIGS. 33A through 33D.

FIG. 33A illustrates the control of the X-axis and the Y-axis in the first control group (A1; FIG. 10) by manipulating the left body (55) of the control unit (51) relative to the right body (56). As illustrated, control of the X-axis and the Y-axis in the first control group (A1; FIG. 10) may be manipulated by the relative planar motion of the left body (55). The planar motion of the left body (55) of the control unit (51) is illustrated with dotted line and the hollow arrows representing motion along both the X-axis and the Y-axis. As noted previously, the relative motion of the left body (55) relative to the right body (56) may be sensed and interpreted by an actuator disposed in the center vertical axis (B2; FIG. 29). Additionally, as noted previously, a number of springs, elastomeric rings, rubber bladders, flexible diaphragms, and/or rubber feet may be used to automatically return the control unit (51) to its original position when released by the user.

FIG. 33B illustrates the control unit (51) being twisted, as illustrated by the curved arrow, to illustrate that the left side (55) of the control unit (51) is rotated relative to the right side (56) of the control unit to generate a yaw-Z signal, according to one exemplary embodiment. Consequently, as illustrated in FIGS. 33A and 33B, at least three additional axes may be controlled by the independent motion of the right (56) and left (55) sides of the control unit (51). As illustrated above, the ergonomic design of the control unit (51) allows the left side (55) of the control unit to be rotated with a user's arm or wrist action without changing hand position.

FIGS. 33C and 33D illustrate the independent motion of the left side (55) of the control unit (51), as viewed from the left side of the control unit (51). As illustrated in FIG. 33C, the rotation of the left body (55) about the center vertical axis (B2; FIG. 29) will control the pitch-X axis of a complicated character, such as an object in a video game. Additionally, as shown in FIG. 33D, the roll-Y axis, also included in the second control group (A2; FIG. 11), may be controlled by the relative rotation of the left body (55) of the control unit (51), according to one exemplary embodiment. As illustrated in FIGS. 33C and 33D, the pivot point for the rotation of the left body (55) is central to the palm position of the control unit (51). Disposing the pivot point for the rotation of the left body in the center of the palm position of the control unit (51) allows the previously mentioned control rotations to be performed by a palm manipulation, leaving the user's fingers free to actuate other controls.

Further illustrated in FIG. 33D, an upward action is illustrated that may be used to generate positive Z-axis control signals, according to one exemplary embodiment. As illustrated in FIG. 33D, the left body (55) of the control unit (51) may be lifted in a positive Z direction relative to the right body (56; FIG. 33A) to generate a positive Z command. Similarly, the negative Z-axis can be controlled by pulling the left body (55) downward.

Although the axes actuators may be located in an orthogonal orientation to each other, the actuators' orientation may be optimized base on user palm orientation and also the shape of the controller unit (51). According to one exemplary embodiment, the actuators controlling the yaw-Z in FIG. 33B and the roll-Y in FIG. 33D are not orthogonal to each other. However, some users may find a non-orthogonal orientation to be more comfortable to operate depending on the exemplary housing shape (51) being used.

While the previously illustrated controller units are described, for ease of explanation only, as having the 6 axes actuators of the control units in the middle of the right and left exemplary housing halves, it is not meant to limit the possibility for locating actuators in any location onto the controller unit, whether in single location or in separate and distinct locations. Additionally, the various actuators may be located on different planes of the controller. While a number of actuator configurations are possible, the configurations ultimately depend on the shape of the controller housing unit. Referring back to FIG. 29, according to one exemplary embodiment with some housing alterations, the actuators for control group 2 (A2; FIG. 11) can be located at the B1 position, while the actuators for control group 1 (A1; FIG. 10) are located along the vertical axis (B2). According to this exemplary configuration, a user can better control a sophisticated character by not mixing yaw-Z signals (A2; FIG. 11) with Y signals (A1; FIG. 10).

One particular advantage of the symmetrically oriented controller is that, according to one exemplary embodiment, left handed or right handed players can be equally accommodated by simply reversing actuator signals, with the help of software, to accommodate user dexterity and preference. Consequently, without performing any hardware alterations, a user can generate equivalent control signals from either the left or the right side of the controller unit.

Moreover, depending on the locations and orientations of the actuators present in the controller unit, the housing of the controller unit can be constructed from many body parts similar to the exemplary non-symmetric control unit illustrated and described above with reference to FIG. 23.

In conclusion, present system and method will allow a more intuitive character controlling experience and will allow effective and pleasurable play of three dimensional games that are currently difficult to control. Effective control of three dimension games may be established by providing a universal and comfortable control unit configured to control nine or more axes of control while allowing all of a user's fingers to be used effectively. Effective use of a user's fingers is accomplished by disposing a number of switches directly on the control unit housing.

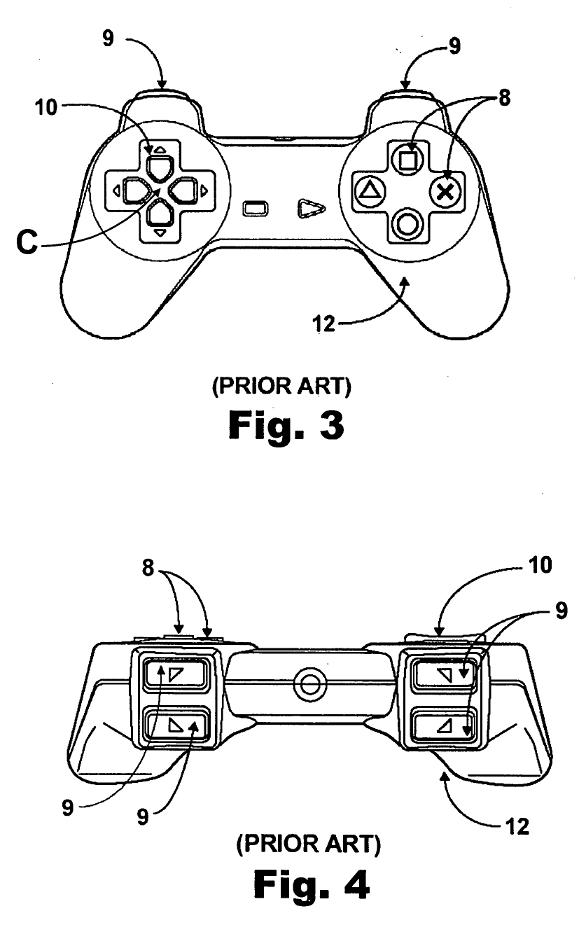

The present specification and its appended claims illustrate and describe an optimum control unit for existing gaming and control systems and methods. It is not intended to be exhaustive or be limited to only the systems and methods disclosed herein. Many modifications and variations are possible. For instance, the above-described control units can be designed to rest on a flat surface while being able to control 9-axis of motion of a sophisticated character with a single hand. Consequently, with a symmetric design, the controller unit would be able to generate more than 18-axis of control to be performed simultaneously by the left and the right hands. This configuration could be useful for controlling realistically sophisticated characters or vehicles. Additionally, a controller unit can be coupled using a single 6 axis actuator. Alternatively, the control unit can be designed to improve the dexterity and freedom of fingers to access action buttons, thumb switches, and hand grips. The teachings of the present system and method may be applied to traditional gamepads, in whole or in part. For instance, the game pad unit illustrated in FIG. 3 above can add a yaw-Z actuator using the present body rotation method at the location (C; FIG. 3). The addition of a simple yaw-Z axis for many traditional gamepads would benefit the 3D gaming experience tremendously, especially for aircraft game and first person view games, a feature that is normally available only to joystick type controller. Additionally the teachings of the present systems and methods can be incorporated into traditional controllers to allow for 2 to 9 axes of controls according to the above-mentioned teachings. Due to the possibility of numerous modifications and variations, it is intended that the scope of the system and method is defined by the following claims:

1. An apparatus for controlling at least one axis of a complex character comprising:
a body:
a first and a second grip member formed in said body, each of said grip members being configured to be contacted with and supported by a palm of a user;
a plurality of control sections mounted to said body, said plurality of control sections being configured to be manipulated by fingers of said user while said palm supports said first or second grip member; and
wherein said first grip member is independently moveable with respect to said second grip member to generate a control command.

2. The apparatus for controlling a complex character of claim 1, wherein said providing control of said at least one axis of motion associated with said complex character comprises:
controlling a first control group associated with a three dimensional translation of said complex character;
controlling a second control group associated with a rotation of said complex character; and
controlling a third control group associated with a viewing window of said complex character.

3. The apparatus of claim 1, wherein
said first and second grip members include two substantially parallel opposing surfaces.

4. The apparatus of claim 3, wherein said first and second grip members are configured to be independently movable without finger interaction.

5. The apparatus of claim 3, wherein said grip member further comprises a plurality of action switches disposed on said first and second grip member.

6. The apparatus of claim 1, wherein said plurality of control sections comprises:
a main joystick body;
a handle base moveably coupled to said main joystick body;
a potentiometer coupled to said main joystick body; and
a joystick actuator coupled to said main joystick body and said handle base;
wherein said potentiometer is configured to generate control signals in response to a movement of said main joystick body;
wherein said joystick actuator is configured to generate control signals in response to a movement of said handle base.

7. The apparatus of claim 1, wherein said plurality of control sections comprises a control pad disposed on said main joystick body;
wherein said control pad is configured to control a viewing window of said complex character.

8. The apparatus of claim 1, wherein said plurality of control sections comprises:
a plurality of action switches arranged in a cross configuration;
a plurality of accessory switches; and
a mini joystick, said mini joystick being readily accessible by a user's right or left digit during operation of said action switches.

9. The apparatus of claim 8, wherein said action switches comprise:
a first action switch configured to control a linear motion of said complex character; and
a second action switch configure to control a secondary motion of said complex character;
wherein said first switch and said second switch have varying textures.

10. The apparatus of claim 1, wherein said apparatus is configured to provide control of at least eight axes of motion associated with said complex character.

11. An apparatus for controlling a complex character comprising:
a body;
a first and a second grip member formed in said body, said first and second grip members including two substantially parallel opposing surfaces, each of said grip members being configured to be contacted with and supported by a palm of a user while being independently movable without finger interaction, and a plurality of action switches disposed on said first and second grip member;
a plurality of control sections mounted to said body, said plurality of control sections being configured to be manipulated by fingers of said user while said palm supports said first or second grip member, said plurality of control sections including a main joystick body, a handle base moveably coupled to said main joystick body, a potentiometer coupled to said main joystick body, a joystick actuator coupled to said main joystick body and said handle base, wherein said potentiometer is configured to generate control signals in response to a movement of said main joystick body, and wherein said joystick actuator is configured to generate control signals in response to a movement of said handle base, and a plurality of action switches arranged in a cross configuration, a plurality of accessory switches, and a mini joystick, said mini joystick being readily accessible by a user's right or left digit during operation of said action switches; and
wherein said first grip member is independently moveable with respect to said second grip member to generate a control command.

12. The apparatus for controlling a complex character of claim 11, wherein said providing control of said complex character comprises:
controlling a first control group associated with a three dimensional translation of said complex character;
controlling a second control group associated with a rotation of said complex character; and
controlling a third control group associated with a viewing window of said complex character.

13. The apparatus of claim 11, wherein said joystick further comprises a control pad disposed on said main joystick body;
wherein said control pad is configured to control a viewing window of said complex character.

14. The apparatus of claim 11, wherein said complex character comprises one of a video game character, a remote control vehicle, a weapons guidance system, or a robotic device.

15. A method for controlling a complex character comprising:
controlling a first control group associated with a three dimensional translation of said complex character;
controlling a second control group associated with a rotation of said complex character; and
controlling a third control group associated with a viewing window of said complex character.

16. The method of claim 15, further comprising assigning a control of each of said first control group, said second control group, and said third control group to independent command receiving components on a control apparatus.

17. The method of claim 16, wherein one of said command receiving components comprises:
a body; and
a first and a second grip member formed in said body, each of said grip members being configured to be contacted with and supported by a palm of a user;
wherein said first grip member is independently moveable with respect to said second grip member to generate a control command.

18. The method of claim 15, further comprising:
programming said complex character to function in response to commands associated with a control of said first control group, said second control group, and said third control group.

19. The method of claim 18, wherein
said first control group is configured to control a lower body of a complicated character;
said second control group is configured to control an upper body of a complicated character; and
said third control group is configured to control visual angles experienced by a complicated character.

20. An apparatus for controlling a complex character comprising:
a body including a first side and a second side, said first side and said second side being independently moveable; and
an actuator disposed between said first side and said second side of said body, said actuator being configured to generate control commands in response to a relative movement of said second side or said first side;
wherein said body is configured to provide control of at least one axis of motion associated with said complex character.

21. The apparatus for controlling a complex character of claim 20, wherein said providing control of said at least one axis of motion associated with said complex character comprises:
controlling a first control group associated with a three dimensional translation of said complex character;
controlling a second control group associated with a rotation of said complex character; and
controlling a third control group associated with a viewing window of said complex character.

22. The apparatus of claim 20, wherein said first side and said second side of said body comprise relatively symmetrical halves.

23. The apparatus of claim 22, wherein:
said first side and said second side of said body include a number of control actuators configured to generate control commands in response to an actuation; and
wherein said control commands are configured to be switched between said first side and said second side of said body to accommodate user dexterity.
